(19) United States
(12) Patent Application Publication
(10) Pub. No.: US 2010/0100824 A1
(43) Pub. Date: Apr. 22, 2010

(54) GRAPHICAL USER INTERFACE FOR RESOURCE MANAGEMENT

(76) Inventors: Claudio Bartolini, Palo Alto, CA (US); Gilad Barash, Tel Aviv (IL); Lionel Fradin, Encinitas, CA (US); Todd Bashor, San Diego, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/253,001

(22) Filed: Oct. 16, 2008

(51) Int. Cl. G06F 3/00

(52) U.S. Cl. 715/738

(57) ABSTRACT

A system comprises a processor and a display coupled to the processor. The processor causes the display to output graphical representations of workgroups based on workgroup data, and the processor accepts as input a constraint to a particular workgroup via manipulation of the particular workgroup's graphical representation. The processor also causes the display to output updated graphical representations of the workgroups based on application of the constraint to the workgroup data.

### BACKGROUND

Workgroups comprise persons and/or infrastructure working together to achieve a goal. For example, a first-level workgroup in a call center comprises human resources and computing resources to successfully resolve (or delegate to another higher-level workgroup) each incoming call. Workgroups can be complex and work at all hours in disparate geographies, especially information technology (“IT”) support workgroups. Also, the dynamics between workgroups are complex and lack transparency. As such, it is difficult to understand the improvement in performance possible via restructuring workgroups by merging, splitting, adding, or eliminating workgroups as well as increasing, decreasing, or moving resources within workgroups. Because of the lack of clear support for restructuring decisions, resources are used inefficiently.

### BRIEF DESCRIPTION OF THE DRAWINGS

For a detailed description of the embodiments of the invention, reference will now be made to the accompanying drawings in which:

FIG. 1A shows a system for resource management in accordance with at least some embodiments;

FIG. 1B shows a system for resource management in accordance with at least some embodiments;

FIG. 2 shows a graphical user interface for resource management in accordance with at least some embodiments;

FIG. 3 shows an updated graphical user interface for resource management in accordance with at least some embodiments;

FIG. 4 shows a geographical view of a graphical user interface for resource management in accordance with at least some embodiments;

FIG. 5 shows a hyperbolic graph and workgroup information pane view of a graphical user interface for resource management in accordance with at least some embodiments; and

FIG. 6 shows a method for resource management in accordance with at least some embodiments.

### NOTATION AND NOMENCLATURE

Certain terms are used throughout the following claims and description to refer to particular components, and different entities may refer to a component by different names. However, this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean an optical, wireless, indirect electrical, or direct electrical connection. Thus, if a first device couples to a second device, that connection may be through an indirect electrical connection via other devices and connections, through a direct optical connection, etc. Additionally, the term “system” refers to a collection of two or more hardware components, and may be used to refer to an electronic device.

A “workgroup” is defined as at least one person and/or infrastructure working together to achieve a goal.

“Graphical representations” of workgroups, which includes graphical representations of relationships between workgroups, is defined as an image symbolizing the workgroup or the relationship, the visual features of the image, e.g., shape, dimension, color, etc., symbolizing metrics or characteristics of the workgroup or relationship, e.g., quantity of productivity of workgroups, derived from workgroup data.

“Workgroup data” is defined as the values of variables about workgroups, e.g., a workgroup comprises 10 human resources, a workgroup is located in Texas, etc.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

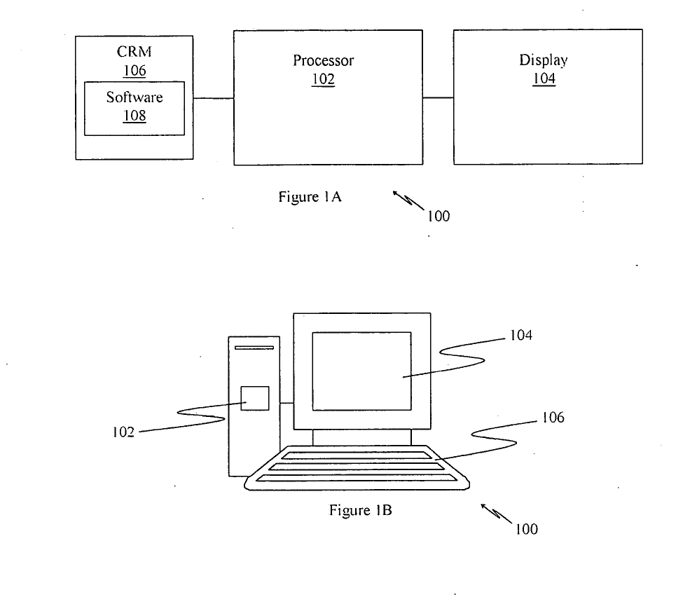

Systems and methods for a graphical user interface (“GUI”) for resource management is disclosed. Preferably, the GUI is a decision support tool for various types of analyses such as performance analysis, business impact analysis, and assisted design of a workgroup hierarchy, all of which provide insight into the structure and the dynamics of the hierarchy. Referring to FIG. 1A, the system 100 comprises a processor 102, a display 104 coupled to the processor 102, and a computer-readable medium 106 coupled to the processor 102. In various embodiments, the computer-readable medium 106 comprises volatile memory (e.g., random access memory, etc.), non-volatile storage (e.g., read only memory, Flash memory, hard disk drive, CD ROM, etc.), and combinations thereof. The computer-readable medium comprises 106 software 108 or firmware executed by the processor 102. One or more of the actions described herein are performed by the processor 102 during execution of the software 108 or firmware.

Referring to FIG. 1B, in at least one embodiment, the system 100 is a computer. As such, the display 104 is a computer monitor and the processor 102 is a computer processor. In at least one embodiment, the system 100 comprises an input device 106. As depicted, the input device 106 is a keyboard. The input device 106 may also comprise a computer mouse, a trackball, a touchpad, etc. However, any type of display, processor, or input device is possible. For example, in at least one embodiment, system 100 comprises multiple processors 102 coupled together in a network. The system 100 comprises a client/server architecture in at least one embodiment.

Preferably, the processor 102 causes the display 104 to output graphical representations of workgroups based on workgroup data. Workgroup data comprises the values of variables about workgroups, e.g., the size of a workgroup, the location of a workgroup, etc. In at least one embodiment, the workgroup data is alphanumeric. Alphanumeric data does not convey information as efficiently or effectively as graphical representations of the workgroup data do. For example, consider a workgroup that requires an increasing yearly cost to operate. Given only alphanumeric data of the yearly cost of the workgroup, it is not immediately apparent whether the rate of increasing yearly cost is increasing or decreasing because additional calculations are required. However, given a chart of the yearly cost of the workgroup, it is immediately apparent whether the rate of increase is increasing or decreasing because the chart conveys the slope of connecting lines between the data points representing yearly cost. In this way, graphical representations of workgroups, including the relationships between workgroups, effectively and efficiently communicate deployment of resources within an entity. The graphical representations can also communicate metrics of the workgroup data. The graphical representations are displayed via a GUI on display 104.

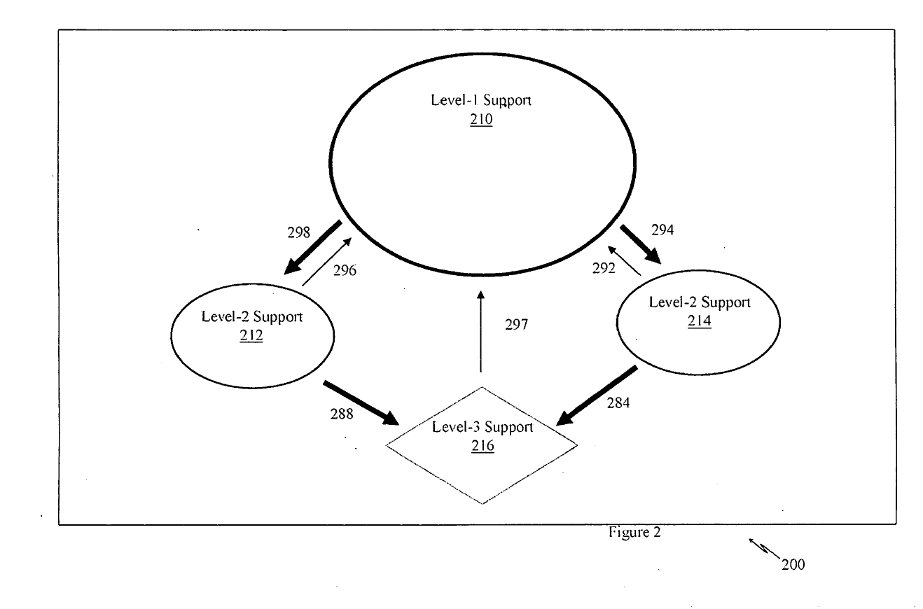

FIG. 2 shows the main view of an illustrative GUI 200. GUI 200 preferably provides graphical representations of workgroups arranged as a hierarchical map. For explanatory purposes, only four graphical representations of workgroups 210, 212, 214, 216 of a call center are depicted. However, the system 100 may be used with any number of workgroups in even non-call-center settings. Preferably, the number of workgroups and metrics of the workgroups will change according to the setting. The graphical representations of workgroups further comprise graphical representations of relationships between workgroups. In at least one embodiment, a graphical representation of a relationship between a first workgroup and a second workgroup comprises two arrows, the first arrow pointing to the graphical representation of the first workgroup from the graphical representation of the second workgroup, and the second arrow pointing to the graphical representation of the second workgroup from the graphical representation of the first workgroup. In at least one embodiment, the arrows 284, 288, 292, 294, 296, 298 represent delegation of responsibility from one workgroup to another workgroup in the direction of the arrow. If delegation of responsibility only occurs in one direction, then only one arrow appears. Note that the arrows 284, 288, 292, 294, 296, 297, 298 do not suggest a long-term continual delegation of responsibility between workgroups, but rather instances of delegation of responsibility over a period of time, which is programmable in at least some embodiments.

A call center connects consumers with knowledgeable staff trained to troubleshoot difficulties the consumer has with a product or service. The connection is preferably over the telephone (voice line) or Internet (data line). The depicted call center of FIG. 2 is divided into three levels of support. Level-1 support comprises workgroup 210. Level-2 support comprises workgroups 212 and 214. Level-3 support comprises workgroup 216. To use resources effectively, workgroups with a higher level number (e.g., level 2 is higher than level 1) comprise staff with greater knowledge than workgroups with a lower level number and workgroups are able to delegate responsibility to other workgroups. Such delegation is preferably in the form of “tickets.” A ticket is a unique identifier associated with a particular call, and the ticket can take the form of a complex data structure with structured variables and values, or the ticket can take the form of a simple variable, e.g., an alphanumeric string. For example, a consumer places a call, and the consumer is connected with a representative in the level-1 support workgroup 210. The level-1 representative takes notes about the problem using a log. The problem is not a common error, and the representative in level-1 is unable to resolve the call successfully. The level-1 representative generates a ticket, associates the log with the ticket, and refers the consumer's error to a representative in one of the level-2 workgroups, e.g., 212, by forwarding the ticket to a level-2 representative in the level-2 workgroup. Preferably, the level-1 representative selects a category for the ticket, e.g., “network,” and the ticket is routed to a level-2 representative that is a specialist in that category, e.g., “network specialist.” The level-2 representative can quickly access the notes and other data from the log using the ticket. Thus, responsibility was delegated from workgroup 210 to workgroup 212. In this way, tickets flow from one workgroup to another in the directions indicated by arrows 284, 288, 292, 294, 296, 297, and 298. Note that occasionally tickets flow from a higher numbered support level to a lower numbered support level 296, 292. This may occur for a variety of reasons, e.g., the consumer had multiple problems, the level-2 representative resolved all but the routine problems, and the level-2 representative referred the consumer's error to a level-1 representative to resolve the routine problems. In this way, the time of the level-2 representative is used efficiently because the level-2 representative is only using knowledge mutually exclusive with the level-1 representative and can handle the next call earlier than if the level-2 representative resolved the routine problems. Also, resources within the workgroup hierarchy are being used efficiently because there are fewer level-2 representatives than level-1 representatives due to the greater knowledge requirement for level-2 representatives and each level-2 representative only solves level-2 problems. In at least one embodiment, a relationship between two workgroups is the delegation of responsibility, i.e., tickets redirected, from each workgroup to the other workgroup.

Visual features of the graphical representations 210, 212, 214, 216, 284, 288, 292, 294, 296, 298 comprise the size, shape, color, shading, and thickness of the border of the graphical representations as well as the layout of the graphical representations, e.g., the distances between graphical representations. The visual features displayed are based on metrics of the workgroup data. For example, in at least one embodiment, the metrics comprise any or all of quantity of productivity of workgroups, quality of productivity of workgroups, quantity of resources of workgroups, quality of resources or workgroups, delegation of responsibility between workgroups, and type of workgroups. Many such metrics are possible. In at least one embodiment, a decision maker can quickly deduce that workgroup 210 resolves the most calls/tickets because the border of workgroup 210 is thicker than the borders of workgroups 212 and 214, which are themselves thicker than the border of workgroup 216. Similarly, the decision maker can quickly deduce that workgroup 216 is of a different type than workgroups 210, 212, and 214 because the shape of workgroup 216 is different than the shape of workgroups 210, 212, and 214. The decision maker can also quickly deduce that workgroup 210 comprises more resources than workgroup 212, 214, and 216 because the size of the graphical representation of workgroup 210 is larger than the sizes of the graphical representations of workgroups 212, 214, and 216. The decision maker can also quickly deduce that workgroup 216 resolves a large percentage all of the tickets delegated to it because the arrow 297 directed away from workgroup 216 is relatively thin. The decision maker can also quickly deduce that level-2 workgroups 212, 214 receive more tickets from the level-1 workgroup 210 than they send to the level-1 workgroup 210 because the arrows representing the tickets are thicker in the direction from the level-1 workgroup 210 to the level-2 workgroups 212, 214. The mapping of metrics to visual features is highly customizable and any metric can be mapped to any visual feature. Each mapping allows for faster deduction of workgroup dynamics than viewing the workgroup data, or even the metrics, in alphanumeric form, e.g., in a table. Though not shown here, the color of a graphical representation of a workgroup is used to represent a metric in at least one embodiment. Also, the mapping may be changed at any time to accommodate the needs of the decision maker.

The processor 102 preferably accepts as input a constraint to a particular workgroup or relationship between workgroups via manipulation or modification by a user of the particular workgroup's or relationship's graphical representation. Consequently, the processor 102 causes the display 104 to output updated graphical representations of the workgroups and relationships based on application of the constraint to the workgroup data. Preferably, the graphical representations are updated each time a constraint is input. In at least one embodiment, application of the constraint to the workgroup data comprises constraining a value of at least one variable of the workgroup data and determining values of any remaining variables of the workgroup data affected by constraining the variable. For example, using a computer mouse, the user can point to the graphical representation of workgroup 210, press the left mouse button, drag the computer mouse pointer away from the center of the graphical representation thus expanding the size of the graphical representation, and release the left mouse button. If the number of resources is mapped to the size of the graphical representation, then by expanding the size of the graphical representation, the user is increasing the number of resources. Thus, a minimum constraint in the number of resources of workgroup 210 will be applied. Consequently, if the average hold time before connection with representative is mapped to the thickness of the border of the graphical representation of the workgroup (less hold time resulting in a thicker border), the border of the graphical representation of the workgroup 210 will be updated to be thicker because the increased resources result in a lesser average hold time before connection with representative. This update occurs without any further input from the user after expanding the graphical representation of workgroup 210. In this way, every affected graphical representation is updated based on the constraints applied.

Examples of constraints that can be applied comprise elimination of a workgroup, addition of a workgroup, merging multiple workgroups into a single workgroup, splitting a workgroup into multiple workgroups, increasing the resources of a workgroup, decreasing the resources of a workgroup, specifying a minimum amount of delegation of responsibility between workgroups, specifying a maximum amount of delegation of responsibility between workgroups, and specifying a ratio of delegation of responsibility between workgroups. Many constraints and combination of restraints are possible.

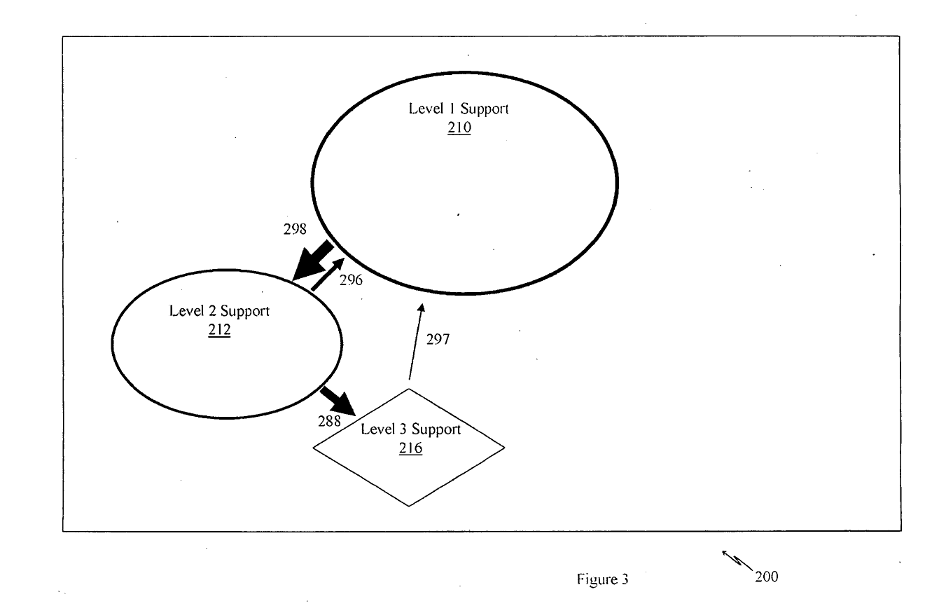

Referring to FIGS. 2 and 3, suppose the decision maker is considering eliminating workgroup 214 and moving some resources of workgroup 214 into workgroup 212. To understand how such a decision would affect the workgroup hierarchy, the decision maker uses the GUI 200 to delete the graphical representation of workgroup 214 by selecting it with the input device 106 and selecting a delete operation, e.g., from a drop-down menu or by pressing the delete key on a keyboard. Next, the user expands workgroup 212 as described above for workgroup 210. The processor 102 applies the constraints to the workgroup data, determines how other workgroup data is affected by the constraints, and causes the display to output FIG. 3. Preferably, the determination is made through the use of a simulator that outputs simulated data. Note that in FIG. 3 workgroup 214 has disappeared along with arrows 284, 292, and 284 due to the hypothetical decisions. Now, only workgroup 212 handles level 2 tickets. Note that the updated graphical representation of workgroup 212 has a thicker border because of the consequent increased resources and increased resolution of tickets resulting from the workgroup 212 now being required to service the deleted workgroup's tickets. Also, workgroup 212 is now physically nearer to workgroup 210 and 216 because of the consequent increased delegation of responsibility between the workgroups. Also, arrows 288, 298, and 296 have increased in thickness because of the consequent increase in throughput of tickets, but arrow 297 has remained the same size because the throughput of tickets between the level three workgroup and the level one workgroup has remained constant. The decision maker now has a clear understanding of how elimination of workgroup 214 and movement of some resources to workgroup 212 will affect the entire hierarchy of workgroups.

In a similar fashion, the decision maker uses the GUI 200 as a guide to carrying out analyses of combinations of scenarios together. Preferably, the processor 102 simulates ticket lifecycles with transition probabilities between workgroups that are set by default to be equal to the frequencies of transitions observed from the workgroup data. For example, if workgroup 212 delegated 25% of its received tickets to workgroup 216 before deletion of workgroup 214, workgroup 212 would still delegate 25% of its tickets to workgroup 216 after deletion of workgroup 214, but the absolute number of tickets would double if workgroup 212 and 214 were servicing the same amount of tickets before deletion of workgroup 214. Similarly, any workgroup data affected by the application of the constraint is updated in the graphical representation of the workgroups proportionally to previous probabilities within the bounds of the constraint. Any violation of the bounds of the constraint or inefficient use of resources, e.g., level-3 workgroup handling level-2 tickets because all level-2 workgroups have been deleted, are preferably flagged with abnormal status indicators.

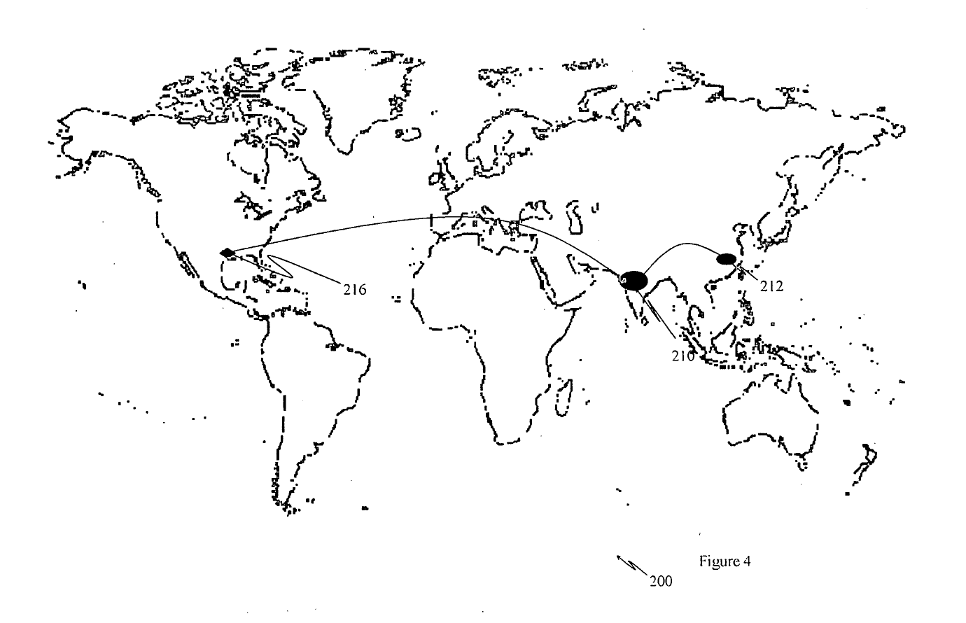

Referring to FIG. 4, the GUI 200 supports a geographical view. The geographical view superimposes the graphical representations of workgroups on a geographical map. As illustrated, workgroup 210 is located in India, workgroup 216 is located in the United States, and workgroup 212 is located in mainland China. This view is helpful to decision makers considering transferring resources between workgroups, communication between workgroups, and how geopolitical events will affect workgroups. As illustrated, a relationship between a pair of workgroups is graphically represented as one curved line.

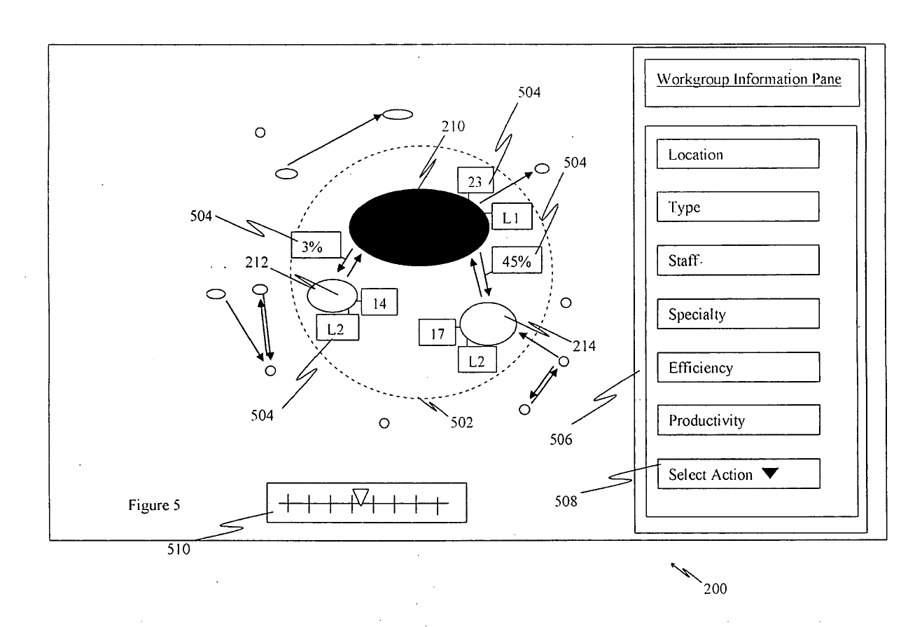

Referring to FIG. 5, the GUI 200 supports a hyperbolic graph view. A large number of workgroups makes a hyperbolic graph ideal. Specifically, the region of the hierarchical map that is in focus, the region enclosed by dashed circle 502, is rendered with greater detail than the rest of the map, but the whole map remains visible. Hyperbolic graphs use hyperbolic geometry to display graphs under a fisheye-like distortion. At any moment, the amount of magnification, and thus the level of visible detail, varies across the display. This allows the user to examine the fine details of a small area while always having a view of the whole graph available as a frame of reference. Objects near the center of the graph are magnified, while those near the boundary are shrunk. The amount of magnification decreases continuously and at an accelerated rate from the center to the boundary, until objects are reduced to zero size at the latter. By bringing different parts of a graph to the magnified central region, enclosed by dashed circle 502, a user can examine every part of the graph in detail.

Secondary attributes of workgroups and their relationships are represented by mini icons 504 drawn near to graphical representations of workgroups, e.g., 210, on the map. As illustrated, the mini icons 504 display textual information about the workgroups and relationships between workgroups. For example, the mini icons 504 surrounding workgroup 210 indicate the workgroup is a level-1 workgroup (“L1”) with 23 human resources (“23”) and redirects 45% (“45%”) of its tickets to workgroup 214. Graphical mini icons are used in at least one embodiment. In at least one embodiment, the mini icons 504 can be enabled and disabled on the GUI 200. In at least one embodiment, a workgroup information pane 506 is displayed. The pane 506 shows information about the selected workgroup such as structural information (name, manager, contacts, location, technicians, specialty, staff, etc.), and collates information useful for performance analysis (number of tickets processed, received ticket/resolved ticket ratio, efficiency, productivity, etc.). As depicted, workgroup 210 is selected and consequently filled in. Preferably, a drop-down menu 508 is provided allowing selected workgroups to be, for example, merged, split, allocated increased resources, allocated decreased resources, given a minimum amount of delegation of responsibility, given a maximum amount of delegation of responsibility, given a ratio of delegation of responsibility, etc.

By default, a workgroup newly created from an original workgroup preferably receives half of the ticket traffic of the original workgroup and has other attributes identical to the original group. However, in at least one embodiment, such behavior is customizable. For example, slide control 510 is used to determine what ratio of tickets the newly created group is expected to handle. For example, workgroup 210 is selected by depressing and releasing the computer mouse while the computer mouse pointer is within the graphical representation of workgroup 210. Next, a “split” operation is selected from drop-down menu 508. As such two workgroups appear in place of workgroup 210, each workgroup half the size of workgroup 210 because each workgroup is expected to receive half the amount of tickets of workgroup 210. These two workgroups are automatically selected. Next, the user adjusts slide control 510 to disproportionately assign the first workgroup more tickets by moving the slider to the left of center. As such, the first workgroup gets larger while the second workgroup gets smaller. Had the user moved the slider to the right of center, the second workgroup would have been assigned more tickets.

In at least one embodiment, the GUI 200 also supports other views of workgroup data (not depicted in the figures). These views may be selected via a drop-down menu, keyboard shortcuts, etc. In at least one view, a particular time period is shown, e.g., first quarter 2007. Only tickets with of a certain category are shown in another view, e.g., only workgroups that troubleshoot network problems are shown and only redirected network tickets are shown. In at least one view, only tickets with a severity rating of 4 or 5 are shown. Combinations of these views can also be shown. For example, only network tickets with a severity rating of 5 are shown, along with the workgroups that handle them. Many such categories, views, and combinations are possible.

In at least one embodiment, the processor 102 causes the display 104 to output an animation of the graphical representations being updated. Returning to FIGS. 2 and 3, FIG. 2 represents the initial state and FIG. 3 represents the updated state. The processor 102 causes the display 104 to output intermediate states such that a smooth transition from the initial state to the updated state can be seen. For example, instead of seeing only the beginning and ending position of workgroup 210, a user would see workgroup 210 approaching its ending position and stopping in its ending position. Simultaneously, a user would see the arrows 288, 296, and 298 shorten and thicken, the border of workgroup 212 thicken, etc. as the animation progresses. In at least one embodiment, the animation also transitions between different periods of time or different views of the GUI 200. Also, in at least one embodiment, the GUI 200 saves a particular view, model, construction, or animation for later viewing. Preferably, the GUI 200 also saves partial organization designs to allow the assisted design process to occur over time.

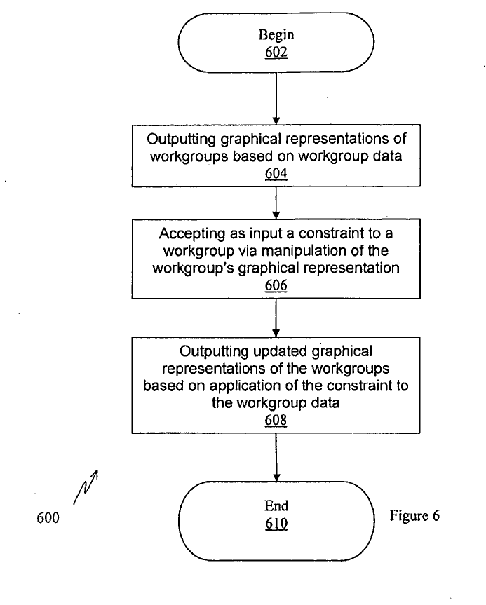

FIG. 6 shows a method 600 for resource management, in accordance with at least some embodiments, beginning at 602 and ending at 610. At 604, graphical representations of workgroups based on workgroup data are output. At 606, a constraint to a particular workgroup is input via manipulation of the particular workgroup's graphical representation. At 608, updated graphical representations of the workgroups, based on application of the constraint to the workgroup data, are output. Preferably, application of the constraint to the workgroup data comprises constraining a value of at least one variable of the workgroup data and determining values of any remaining variables of the workgroup data affected by the constraint of the variable.

Returning to FIG. 1A, one or more of the actions described herein are performed by the processor 102 during execution of the software 108 or firmware. Preferably the computer-readable medium 108 stores a software 108 program that, when executed by the processor 102, causes the processor 102 to output graphical representations of workgroups based on workgroup data, accept as input a constraint to a particular workgroup via manipulation of the particular workgroup's graphical representation, and output updated graphical representations of the workgroups based on application of the constraint to the workgroup data. Preferably, application of the constraint to the workgroup data causes the processor 102 to constrain a value of at least one variable of the workgroup data and determine values of any remaining variables of the workgroup data affected by the constraining of the at least one variable.

The above discussion is meant to be illustrative of the principles and various embodiments of the present invention. Numerous variations and modifications will become apparent to those having ordinary skill in the art once the above disclosure is fully appreciated. It is intended that the following claims be interpreted to embrace all such variations and modifications.

What is claimed is:

1. A system, comprising:
a processor; and
a display coupled to the processor;
wherein the processor causes the display to output graphical representations of workgroups based on workgroup data;
wherein the processor accepts as input a constraint to a particular workgroup via manipulation of the particular workgroup's graphical representation; and
wherein the processor causes the display to output updated graphical representations of the workgroups based on application of the constraint to the workgroup data.

2. The system of claim 1, wherein the graphical representations of workgroups further comprise graphical representations of relationships between workgroups, the graphical representations of relationships between workgroups manipulatable to input the constraint.

3. The system of claim 2, wherein a graphical representation of a relationship between a first workgroup and a second workgroup comprises two arrows, the first arrow pointing to the graphical representation of the first workgroup from the graphical representation of the second workgroup, the second arrow pointing to the graphical representation of the second workgroup from the graphical representation of the first workgroup, the first arrow increasing in thickness as an amount of delegation of responsibility from second workgroup to the first workgroup increases, the second arrow increasing in thickness as an amount of delegation of responsibility from the first workgroup to the second workgroup increases.

4. The system of claim 1, wherein each graphical representation comprises at least one visual feature selected from the group consisting of size of the graphical representations;
shape of the graphical representations;
color of the graphical representations;
distances between graphical representations; and
thickness of border of the graphical representations and each visual feature is based on a metric of the workgroup data.

5. The system of claim 4, wherein the metric is selected from the group consisting of quantity of productivity of workgroups;
quality of productivity of workgroups;
quantity of resources of workgroups;
quality of resources or workgroups;
delegation of responsibility between workgroups; and
type of workgroups.

6. The system of claim 1, wherein the constraint is selected from a group consisting of elimination of a workgroup, addition of a workgroup, merger of multiple workgroups into a single workgroup, split of a workgroup into multiple workgroups, an increase in resources of a workgroup, a decrease in resources of a workgroup, specification of a minimum amount of delegation of responsibility between workgroups, specification of a maximum amount of delegation of responsibility between workgroups, and specification of a ratio of delegation of responsibility between workgroups.

7. The system of claim 1, wherein application of the constraint to the workgroup data comprises constraint of a value of at least one variable of the workgroup data and determination of values of any remaining variables of the workgroup data affected by the constraining of the at least one variable.

8. The system of claim 1, wherein, as a total amount of delegation of responsibility between workgroups increases or decreases, the layout of the graphical representations changes in proportion to the amount of increase or decrease respectively.

9. The system of claim 1, wherein the processor causes the display to output a hyperbolic graph comprising the graphical representations.

10. The system of claim 1, wherein the processor causes the display to output an animation of the graphical representations being updated.

11. The system of claim 1, wherein the workgroup data is alphanumeric.

12. A computer-readable medium storing a software program that, when executed by a processor, causes the processor to:
output graphical representations of workgroups based on workgroup data;
accept as input a constraint to a particular workgroup via manipulation of the particular workgroup's graphical representation; and
output updated graphical representations of the workgroups based on application of the constraint to the workgroup data.

13. The computer-readable medium of claim 12, wherein application of the constraint to the workgroup data causes the processor to constrain a value of at least one variable of the workgroup data and determine values of any remaining variables of the workgroup data affected by the constraining of the at least one variable.

14. A method, comprising:
outputting graphical representations of workgroups based on workgroup data;
accepting as input a constraint to a particular workgroup via manipulation of the particular workgroup's graphical representation; and
outputting updated graphical representations of the workgroups based on application of the constraint to the workgroup data.

15. The method of claim 14, wherein application of the constraint to the workgroup data comprises constraining a value of at least one variable of the workgroup data and determining values of any remaining variables of the workgroup data affected by the constraining of the at least one variable.
